(19) United States
(12) Patent Application Publication
(10) Pub. No.: US 2015/0127411 A1
(43) Pub. Date: May 7, 2015

(54) WORKFLOW RULES ENGINE

(71) Applicant: BANK OF AMERICA CORPORATION, CHARLOTTE, NC (US)

(72) Inventors: HUDSON PHILIP HOEN, IV, Wilmington, DE (US); JASON N. ALEXANDRIAN, Braselton, GA (US)

(73) Assignee: BANK OF AMERICA CORPORATION, CHARLOTTE, NC (US)

(21) Appl. No.: 14/071,955

(22) Filed: Nov. 5, 2013

(51) Int. Cl. G06Q 10/06

(52) U.S. Cl. CPC G06Q 10/06316
USPC 705/7.26

(57) ABSTRACT

Embodiments of the invention relate to systems, methods, and computer program products for providing a workflow rules engine. The system, method, and computer program product are configured to receive data associated with a plurality of events; determine an identity of a user reviewing at least one of the plurality of events; receive a workflow rule from the user relating to at least one of the plurality of events, wherein the workflow rule causes an action to occur in response to a future occurrence of the event; and implement the rule for future events. The system allows a user to personally configure actions that occur in response to events determined by the system during, for example, a phone call with a customer.

### BACKGROUND

Representatives of institutions, such as financial institutions, often contact customers for various reasons. For example, a representative of a financial institution may contact a customer to discuss a financial account. Representatives and managers may desire to customize the alerts and information they receive from the computerized system in order to provide better service to the customers during the communication. Many different events occur during a communication with a customer and it can be difficult to track all of the events and the actions that should be taken in response. For example, when a customer opens a new account a representative may desire to provide information on the benefits of the new account. Thus, there is a need for a customizable system that allows a user to specify actions that occur in response to events during the customer communication.

### SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

In an aspect, a system for providing a workflow rules engine is provided. In an embodiment, the system includes a computer apparatus including a processor and a memory; and a software module stored in the memory, comprising executable instructions that when executed by the processor cause the processor to: receive data associated with a plurality of events; determine an identity of a user reviewing at least one of the plurality of events; receive a workflow rule from the user relating to at least one of the plurality of events, wherein the workflow rule causes an action to occur in response to a future occurrence of the event; and implement the rule for future events.

In some embodiments, the module is further configured to: determine qualifications of the user based on the user's identity; and determine a subset of events that the user is allowed to control with a workflow rule based on the user's qualifications.

In another aspect, a computer program product for providing a workflow rules engine is provided. In some embodiments, the computer program product includes a non-transitory computer readable storage medium having computer readable program code embodied therewith, the computer readable program code comprising: a computer readable program code configured to receive data associated with a plurality of events; a computer readable program code configured to determine an identity of a user reviewing at least one of the plurality of events; a computer readable program code configured to receive a workflow rule from the user relating to at least one of the plurality of events, wherein the workflow rule causes an action to occur in response to a future occurrence of the event; and a computer readable program code configured to implement the rule for future events.

In a still further aspect, a method for providing a workflow rules engine is provided. In some embodiments, the method includes receiving data associated with a plurality of events; determining, via a computing device processor, an identity of a user reviewing at least one of the plurality of events; receiving a workflow rule from the user relating to at least one of the plurality of events, wherein the workflow rule causes an action to occur in response to a future occurrence of the event; and implementing, via a computing device processor, the rule for future events.

In some embodiments, the event is selected from the group consisting of a customer contact in a specific location, a customer contact at a specific frequency, a customer contact at a specific time, and a new account opening.

In some embodiments, the workflow rule causes information to be provided to a representative when the future event occurs.

In some embodiments, the system, computer program product, and method is further configured to: supplement the workflow rule with data associated with the customer; and provide the data to the representative when the information is provided.

In some embodiments, implementing the rule for future events includes receiving a generic subscription to all events in the system; comparing the event of the workflow rule to current events; and causing the action to occur based on the comparison between the workflow rule event and the current events.

In some embodiments, receiving the workflow rule from the user includes providing a graphical toolbox, wherein the graphical toolbox comprises selectable modular events and actions; and receiving one or more selections of events and actions from the user.

Other aspects and features, as recited by the claims, will become apparent to those skilled in the art upon review of the following non-limited detailed description of the invention in conjunction with the accompanying figures.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a high level process flow illustrating the unified recovery process, in accordance with one embodiment of the present disclosure;

FIG. 2 provides a high level process flow illustrating the unified recovery system process, in accordance with one embodiment of the present disclosure;

FIG. 3 is a flow diagram illustrating a high-level process flow for a system and method for implementing a workflow rules engine, in accordance with embodiments of the disclosure;

FIG. 4 is an exemplary depiction of implementation of the workflow rules engine, in accordance with an embodiment of the disclosure;

FIG. 5 is an exemplary screenshot of a graphical representation of a file menu for creating, loading, saving, and running workflows, in accordance with embodiments of the disclosure;

FIG. 6 is an exemplary screenshot of a graphical representation of an event creation window, in accordance with embodiments of the disclosure;

FIG. 7 is an exemplary screenshot of a graphical representation of a workflow toolbox, in accordance with embodiments of the disclosure;

FIG. 8 is an exemplary screenshot of a graphical representation of a workflows window, in accordance with embodiments of the disclosure;

FIG. 9 is an exemplary screenshot of a graphical representation of a workflow sequence menu, in accordance with embodiments of the disclosure;

FIG. 10 is a block diagram illustrating exemplary technical components of a financial institution banking system, in accordance with an embodiment of the present disclosure; and

FIG. 11 is a block diagram illustrating exemplary technical components of a system for implementing a workflow rules engine, in accordance with an embodiment of the present disclosure.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” It should also be understood that while some embodiments describe the methods or products as comprising one or more elements, the methods or elements may also consist of or consist essentially of the elements disclosed herein.

Although embodiments of the present invention described herein are generally described as involving a merchant, it will be understood that merchant may involve one or more persons, organizations, businesses, institutions and/or other entities such as financial institutions, services providers that implement one or more portions of one or more of the embodiments described and/or contemplated herein.

Apparatus, systems, methods and computer program products are herein disclosed for implementing a workflow rules engine. Inasmuch as financial institutions use workflow rules engines to provide flexibility in managing workflows, specific embodiments disclosed herein relate to financial institutions. However, such embodiments are exemplary.

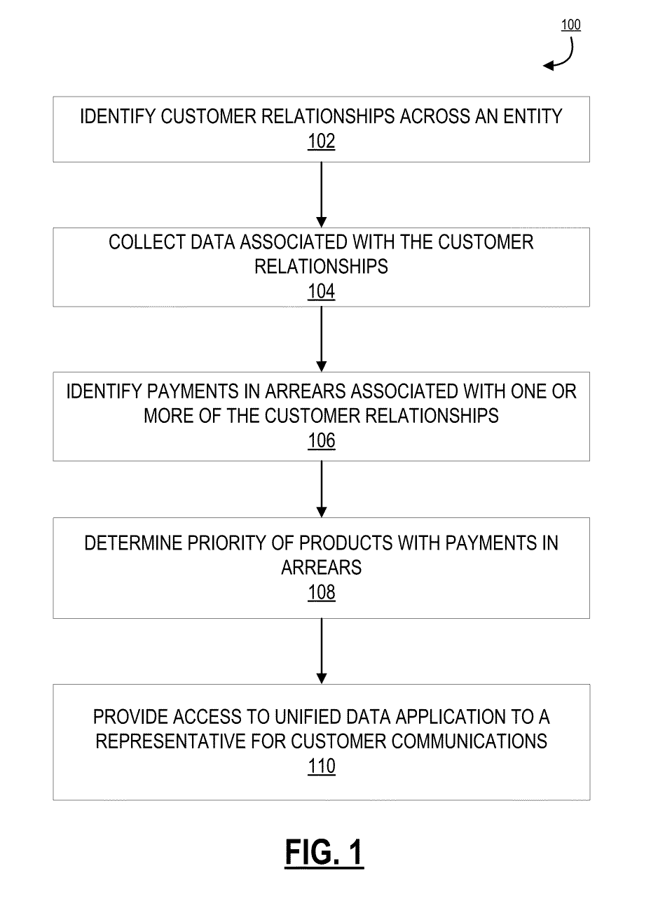

FIG. 1 illustrates a high level process flow for a unified recovery process 100 in which the workflow rules engine may be used. As illustrated in block 102, the process 100 begins with identifying customer relationships across an entity. In this way, the system may identify all products that a customer may have with the entity across one or more lines of business within the entity. As such, addresses, affiliates, phone numbers, customer products, products with payments that are in arrears, and any other information that may be associated with a single customer may be gathered across the lines of business of an entity. Next, as illustrated in block 104, the data associated with the customer relationships may be collected and compiled in association with the customer. As such, all relationship data may be stored in association with a customer including those products and/or accounts that are in arrears.

The next step in the process 100, as illustrated in block 106, is to identify payments in arrears associated with the customer. As such, the products or accounts that have payments in arrears that are associated with that particular customer are identified. A product or account with a payment in arrears may be qualified as being in arrears based on the entity itself and/or agreements for payment between the customer and the entity. For example, after the due date for payment for the product or after a predetermined number of days after the due date, the product may be considered by the entity to be in arrears. Furthermore, the accounts or products with payments in arrears for people affiliated with that customer, such as when the customer is a guarantor for the associate or the like, may also be identified by the system. People affiliated with the customer may include friends, family, or the like associated with the customer.

As illustrated in block 108, the system determines the priority of the products with payments in arrears. In this way, the system may determine which products in arrears should take priority over the other products for purposes of recovery of payments. The primary account for recover is the account or product that the entity has identified as having payment in arrears that is the one which needs to be recovered first. This may be based on entity determination, interest rate, amount, importance, or the like. As such, the system may identify the products with payments in arrears that are the most important to recover first ahead of the other payment products. Thus, the representative may focus on recovering payments for that identified product.

Finally, as illustrated in block 110, the process 100 continues by providing access to a unified application to a representative for customer communications. The unified application provides the representative with an across the entity view of the customer's relationship with the entity as well as information associated with the primary account and other accounts with payments in arrears. The unified application may also use the system and method for the workflow rules engine to allow customized responses and actions to events that occur during the unified recovery process. Finally, the unified application also provides information associated with prior customer communications. As such, the invention provides a holistic customer service experience for a customer with accounts in arrears.

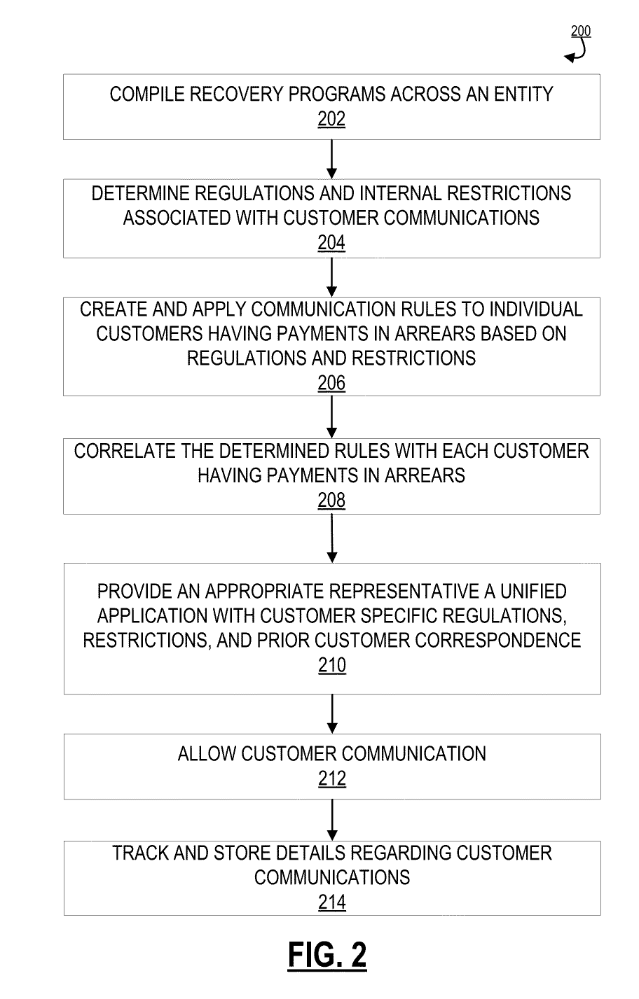

FIG. 2 illustrates a high level process flow for the unified recovery system process 200, in accordance with one embodiment of the present disclosure. The process 200 describes a high level of the unified recovery system's steps to providing a representative with the unified application to aid in payment in arrears recovery. First, as illustrated in block 202, the system compiles the various recovery programs across the entity. In this way, all recovery programs may be centralized, such that the representative can log into a single system. This eliminates requiring the representative to log into a plurality of software programs in order to view and understand all relationships a customer has with the entity.

Next, as illustrated in block 204, the system may determine regulations and internal restrictions associated with individual customer communications. Regulations may include laws or other regulations regarding the time of day a customer may be contacted, the amount of times within a given day/week/month that a customer may be contacted, a telephone number in which a customer may be contacted, or the like. As such, the system ensures that the representative is following all regulations and/or laws regarding the contacting of customers with products having payments in arrears. Internal regulations may include any rule that an entity may put in place to restrict or warn a representative prior to the representative contacting a customer or during the representative's communication with the customer. For example, an internal regulation may be set based on a customer communication preference, such as a specific telephone number to utilize for communications with the customer. In another example, the entity may identify an event that requires the entity to delay in communicating with a customer regarding a product with a payment in arrears (e.g., a natural disaster in the geographic are where the customer is located or another known event that may interfere with a customer providing payment).

In some embodiments, the regulations or restrictions may, in some instances, be overridden by the representative. In this way, the representative may still contact the customer even if a regulation or restriction is in place. The representative may need to input a reason for overriding the regulation or restriction. In some embodiments, the regulation or restriction may not be overridden by any representative. In this way, the system will not allow the representative to communicate with the customer at that time. In some embodiments, no regulation or restriction may be placed on a customer communication. As such, the representative may contact the customer at any time.

Next, as illustrated in block 206 the system may utilize the regulations and restrictions to create rules for customer communications. These rules may be created and applied to a customer on a customer-by-customer basis. In this way, each customer, based on the customer's location, telephone number, or the like, may have a unique set of rules applied for him/her based on regulations and/or restrictions that may apply to the customer having payments in arrears for products. Next, once the rules have been created and applied in block 206, the determined rules may be correlated with each individual customer having payments in arrears, as illustrated in block 208. In some embodiments, the system to determine permission to contact is also used to determine rules for when a customer may be contacted.

As illustrated in block 210 of FIG. 2, the system may provide a unified application for displaying a customer relationship to an appropriate representative. The unified application has specific regulations, restrictions, and prior customer correspondence associated therewith. An appropriate representative may be identified by the system based on which representative has experience with that particular customer, knowledge with a particular account in arrears, or general expertise regarding a field associated with the primary account for recovery. The system may identify and match the customer with the appropriate representative based on these factors.

Next, as illustrated in block 212 the system may allow the representative to initiate a communication with the customer. Allowing the representative to initiate a communication with a customer may be based on the determined regulations and restrictions. In some embodiments, the regulations and restrictions will not allow a representative to communicate with the customer. In some embodiments, the regulations and restrictions will warn against communicating with the customer. However, a representative may be able to override the warning. In some embodiments, the regulations and restrictions will allow a representative to communicate with the customer.

Finally, as illustrated in block 214, the system may track and store details regarding the customer communications. In this way, the system may track the disposition of the communication, such as determining if a communication was answered by the customer, a busy signal was received, or that the customer answered the communication. The system may identify the date, time, means of communication (such as specific telephone number, email address, or the like). Furthermore, the system may store any comments or notes made by the representative during the communications.

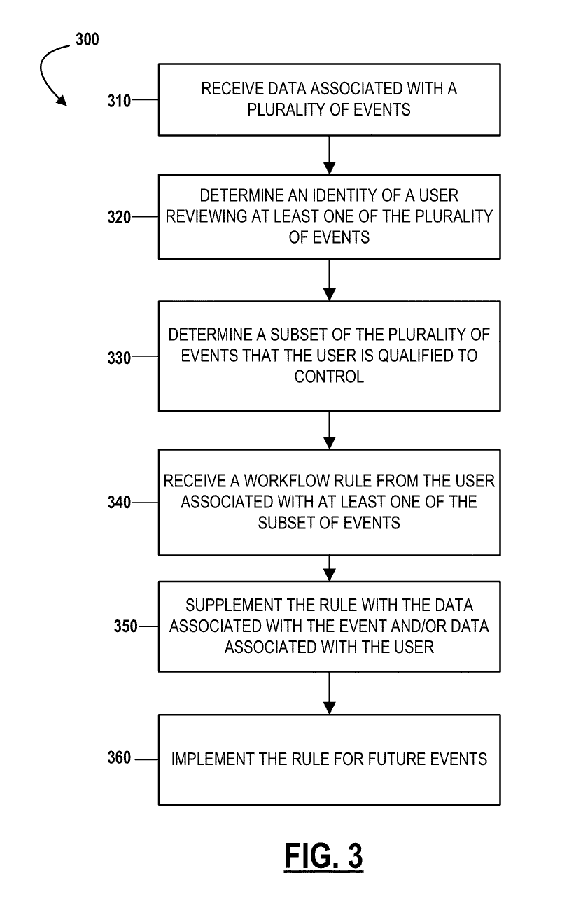

FIG. 3 illustrates a general process flow 300 for an apparatus or system for implementing a workflow rules engine consistent with an embodiment of the present invention. In some embodiments, the system receives data associated with a plurality of events; determines an identity of a user reviewing at least one of the plurality of events; receives a workflow rule from the user relating to at least one of the plurality of events, wherein the workflow rule causes an action to occur in response to a future occurrence of the event; and implements the rule for future events. The workflow rules engine allows users, such as administrators of a system, to implement changes to informational and assisted actions without technical intervention. Advantageously, an administrator could add or change rules using the system without requiring significant coding changes. Instead, the system provides a system that assists the user through the process and implements the rules without technical intervention.

As shown in block 310, the system receives data associated with a plurality of events. An event is an action that occurs as part of a computer system. In an embodiment, an event is an action that is performed by a user of a computer system, such as a representative of a financial institution that is speaking with or about to speak with a customer of the financial institution. For example, an event may be a user opening a window or clicking a button to cause an action to occur (e.g., dialing a customer). In a further embodiment, an event is an action that is performed by the computer system, either automatically or in response to an external action. For example, the computer system may automatically save a record of a phone call. In another example, a customer may end a phone call and thereby trigger an event such as call up of a new customer. In a still further embodiment, an event is a period of time without a specific action occurring. For example, the system may identify an event as ten minutes without the representative making a phone call to a customer. It should be understood that many different types of events occur in computing systems, from actions that are undertaken by users of the system to actions that occur in response to external events. The examples disclosed herein are merely exemplary and other types of events are possible.

In an embodiment, the data is received continuously. For example, the system may monitor a teleconferencing facility or program that enables communication between representatives of a financial institution and customers. As the system monitors the teleconferencing facility or program, data is continuously received by the system on actions performed by participants or elements of the teleconferencing facility. In a further embodiment, the data is received intermittently, such as at a predetermined time period, or on demand by an administrator or representative.

In an embodiment, the system receives data on a plurality of events. The plurality includes at least one event. In an exemplary embodiment, the plurality is all of the events received by the system. Given enhanced computing capabilities, the system serves a receiving port that receives data on actions in a large system and, as will be discussed, filters the data to identify actions that the user is qualified to control.

In block 320, the system determines an identity of a user reviewing at least one of the plurality of events. In an embodiment, the user is an administrator of the system. The administrator may be establishing a new set of rules and/or actions that take place in response to an event occurring. The system determines the identity of the user based on an identifying characteristic of the user. For example, the user may enter a username and password before accessing the system. In another example, the user is associated with a workstation at which the system is being executed.

In an embodiment, the system determines the current user and stores the current user in a database or in short-term memory until the system determines that a new user has been entered into the system. For example, the system may determine that a first user logged in. The system identifies the first user based on the log-in credentials and proceeds based on the identity until the first user logs out or a second user logs in.

In an embodiment, the identity of the user comprises not only identifying information, such as name, title, and the like, but also qualifications and permissions for accessing portions of the system, determining and/or changing workflow rules, and having access to supplemental data. Different users may have access to different types of rules and different data.

In an embodiment, the user is reviewing the events by accessing a directory structure comprising data associated with the plurality of events. For example, the directory structure may include categories for different events that have occurred or are occurring. A first category may include events caused by an action of the representative; a second category may include events caused by an action of the customer; a third category may include events automatically initiated by the system. As should be understood, the variety and types of events that occur as part of the teleconference system are not limited to these categories. Instead, the categories may be customizable or default. In an embodiment, a user may establish personal categories. In an embodiment, the categories are tiered. For example, a high level category may be an event that comprises an action of a customer. A lower level category may be a customer opening a new account, which is a type of event comprising an action of a customer. An even lower level category may be a customer opening a specific type of account. By providing these events, categories, and in some cases tiers to the user, the user is able to define which events trigger a response by the system.

In block 330, the system determines a subset of the plurality of events that the user is qualified to control. As discussed, different users have different qualifications and may have different access permissions. For example, a high level administrator may have access to all events captured by the system. A mid-level administrator may have access to specific events associated with customers, but not to events associated with other employees of the financial institution. A specialized administrator may have access to all events associated with the administrator's specialty but no events outside of the specialty.

In some embodiments, the subset is some but not all of the events. In other embodiments, however, the subset may range from no events to all of the events. As events occur or as the qualifications of the user change, the subset may change as well. For example, a user may have access to a first subset of events but be given access to a second, larger subset when the user's supervisor changes the user's qualifications.

In an embodiment, qualified to control means that the user is permitted by the system to establish rules or alerts related to an event. The user may be permitted to establish a pop-up alert when the system determines that the recipient of a phone call resides in a state that is has prohibitions on questions asked by representatives of financial institutions during a phone call.

In an embodiment, a table is provided that provides the relationship between events and qualifications such that the table is reviewed to determine what events the user is qualified to control. The subset may also be determined dynamically, such as by querying the user or another representative associated with the system. In an embodiment, the subset is further limited based on search criteria of the user. For example, a first subset may comprise events that the user is qualified to control. The user defines a search query that selects a second subset from the first subset. For example, the user may set up a search query that limits the first subset to events for which the user may establish automatic transfers of a phone call to other representatives. In this example, events that are not associated with automatic transfers (e.g., events that are not associated with a phone call) are excluded from the second subset. In this manner, the subset includes events that the user is both qualified to control and interested in controlling.

In block 340, the system receives a workflow rule from the user associated with the at least one of the subset of events. The workflow rule is an action that is taken by the system in response to the event occurring. For example, the system may determine that a representative is speaking on the phone with a customer in a specific state. Speaking with the customer in the specific state is the event. The action, as defined by the user, may be to cause an informational pop-up to be displayed to the representative providing information on regulations related to the specific state.

In an embodiment, the user provides the workflow rule via a graphical user interface that prompts the user to select pre-defined modular actions in response to defined events. In another embodiment, the system receives text associated with a programming language from the user.

In one embodiment, an example of a workflow rule may be an action that occurs in response to contacting a customer in a specific location. For example, a pop-up notice may be displayed to a representative when the representative calls a customer in a specific location. The pop-up notice provides information to the representative regarding the customer's location, including rules of contact that apply to the location, information on local happenings, and the like.

In another embodiment, a workflow rule may be devised based on the frequency of contact with a customer. For example, a user may set up a workflow rule that advises the representative of the previous time the customer was contacted, the number of contacts that have happened with the customer in the a predetermined time period, and the number of remaining permissible contacts. This pop-up action is in response to the system determining the event of contacting a customer a specific number of times within a predetermined time period.

In a still further embodiment, a workflow rule may be implemented based on the action of contacting a customer that has not provided permission to be contacted via an automatic communication system. For example, in 1991, the Telephone Consumer Protection Act (TCPA) was passed by the United Stated Congress and signed into law. One provision of the TCPA prevents automated telephone equipment from dialing any telephone number assigned to a paging service, cellular telephone service, specialized mobile radio service, or other radio common carrier service, or any service for which the called party is charged for the call without the prior express consent of the called party. The workflow rule may comprise the event that a customer who has not provided express consent is contacted and the action that the representative is prompted to ask for consent.

In a still further embodiment, a workflow rule may be implemented wherein a representative is prevented from contacting a customer. For example, a contact for a customer may be on a do not call list, may have reached the permissible number of contacts within a time period, or may be in use by another representative. If the representative attempts to contact a customer that is not available (the event), the system may display a pop-up or informational guide informing the representative why the customer is not available, and in some embodiments providing the representative a chance to override the restriction if an appropriate exception is provided.

In some embodiments, the workflow rule may provide assistance or help to a representative. For example, context-sensitive help may be provided to a customer when the customer accesses a specific screen or subject matter area in the system. The workflow rule then provides a window or access to assistance related to the specific screen or subject matter area. In some embodiments, the workflow rule directs the user to specific articles related to the screen or subject matter area.

In further embodiments, the workflow rule may determine that the user is attempting to complete a specific action (e.g., opening a new account for a customer) but that the user has not completed required or recommended steps prior to the specific action. For example, it may be required to input a customer's identification number prior to opening a new account. If the representative is setting up a new account but has not yet input the customer's identification number, the system can identify this and open up a window or request input related to the required information. Similarly, it may be considered a best practice to request express permission to contact via an automatic dialer when setting up a new account. If the representative has not indicated whether express permission has been received, the window requesting that information may be displayed to the representative as a new account is being set up. This automatic prompt of needed or desired information in response to an account taken by the user assists the system and the user.

Turning now to decision block 350, in some embodiments the system supplements the rule with the data associated with the event and/or data associated with the user. For example, the user may establish a workflow rule that causes an information pop-up to appear when a customer is dialed for the first time. The informational pop-up may be supplemented with demographic information for the customer by the system. For example, a representative may be calling a customer about an account for the first time. An informational pop-up providing the current status of the account may be displayed. The system may also supplement the informational pop-up with information from the financial institution, such as the date the customer affiliated with the financial institution, the billing address of the customer, and/or current information on the customer (e.g., employer, local weather, and the like).

In an embodiment, the supplemental data are data associated with the event. For example, the event may be calling a customer in a specific state. The supplemental data may relate to the state, such as donations made by the financial institution in the state, the location of offices in the state, or the like. In another embodiment, the supplemental data are data associated with the user. For example, the user may be a representative of a financial institution and the supplemental data may include the number of phone call made to customers in the current day. In a still further embodiment, the supplemental data are data associated with the recipient of the phone call, such as the recipient's preferred name, the recipient's address, and the like.

In block 360, the system implements the rule for future events. By implementing, the system causes the action to occur when the event is detected. In some embodiments, the rule is implemented for all future events. In another embodiment, the rule is implemented for certain users, such as the specific user providing the rule, all representatives on the user's team, or another subset of the users of the system.

The rule may be implemented at a predetermined time in the future. For example, in some embodiments, the rule is implemented after a reload of the system rules. In another embodiment, however, the rule is implemented immediately after being provided by the user.

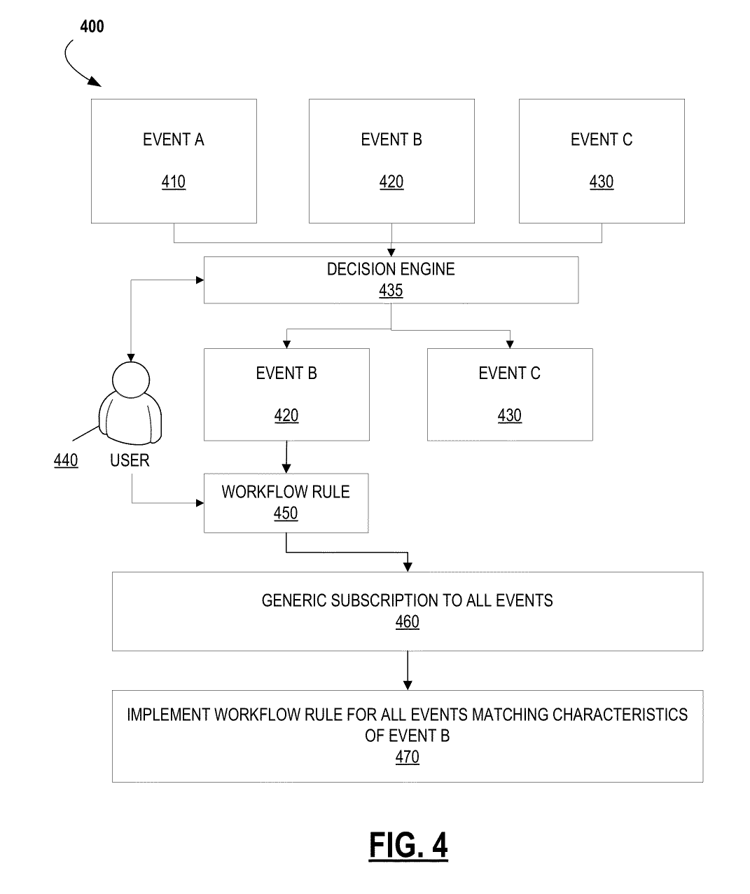

FIG. 4 provides a general process flow 400 for a diagram depicting implementation of the workflow rules engine, in accordance with an embodiment of the invention. A decision engine 435 determines which events 410, 420, 430 the user 440 is qualified to control. In this example, the decision engine 435 determines that the user 440 is qualified to control event B 420 and event C 430. The user 440 then provides a workflow rule 450 associated with at least one of the events, in this case event B 420.

The workflow rule 450 may be applied for all future events for the user 440, for other users as specified by the user 440, or for all occurrences of the event across the system. In block 460, the system receives a generic subscription to all events. In this manner, the system tracks events as they are occurring.

When the system determines that an event has occurred, such as event B (e.g., phone call to a customer whom has not provided express consent to be contact via an automatic dialing system), the system implements the workflow rule 450 provided by the user 440 (e.g., the system prompts a representative on the call with the customer to request express consent), as shown in block 470.

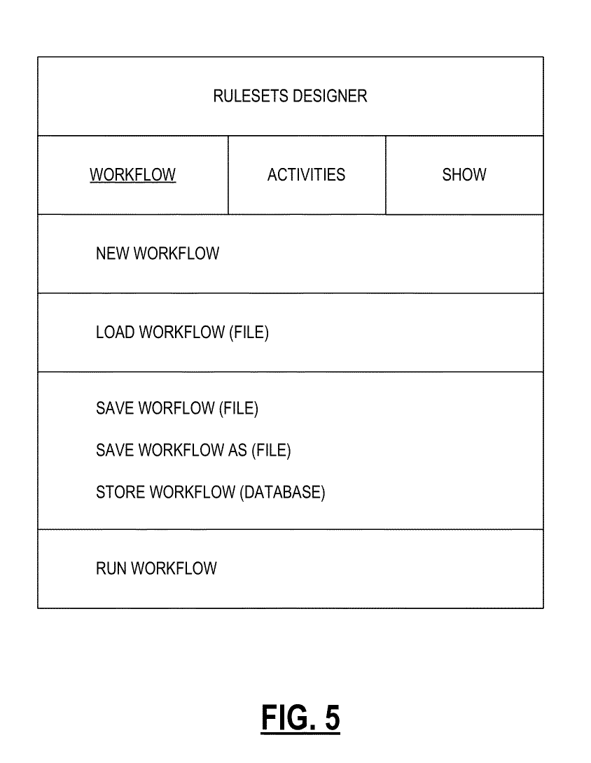

Referring now to FIG. 5, an exemplary screenshot of a graphical representation of a file menu for creating, loading, saving, and running workflows is provided, in accordance with embodiments of the disclosure. The file menu provides users with workflow options such as creating a new workflow, loading a workflow from a file, saving a workflow to a file, saving a workflow as a new file name to a file, storing a workflow in a database, and running a workflow.

A new workflow allows a user to create a new workflow using the graphical user interfaces associated with the system. Loading a workflow allows a user to access a saved workflow and either implement it, edit it, or delete it. Once a user has created or modified a workflow, the user can save the workflow in various ways, such as to a file or into a database. Finally, the user can run or implement the workflow for future events.

It will be understood that the display page 500 can be embodied as portions of a dashboard application, portions of a portal application, as intranet pages, as Internet web pages, as the display associated with a mobile application, and/or the like.

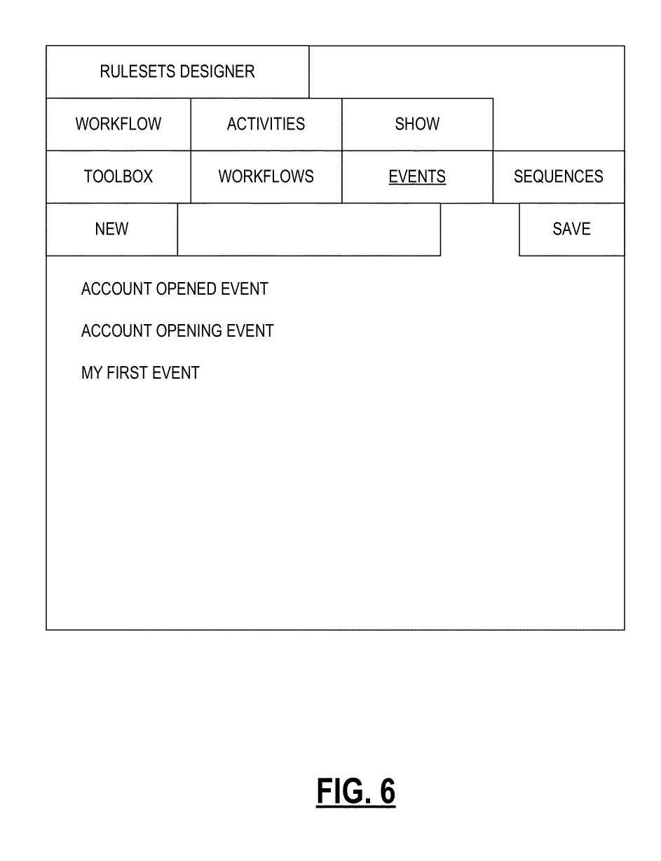

In FIG. 6, an exemplary screenshot of a graphical representation of an event creation window is provided, in accordance with embodiments of the disclosure. When a user decides to create a workflow rule, the user determines both an event and an action that is triggered by the event. The event creation window allows the user to view previously created events, such as account opened event and account opening events. These events may be incorporated into new workflow rules.

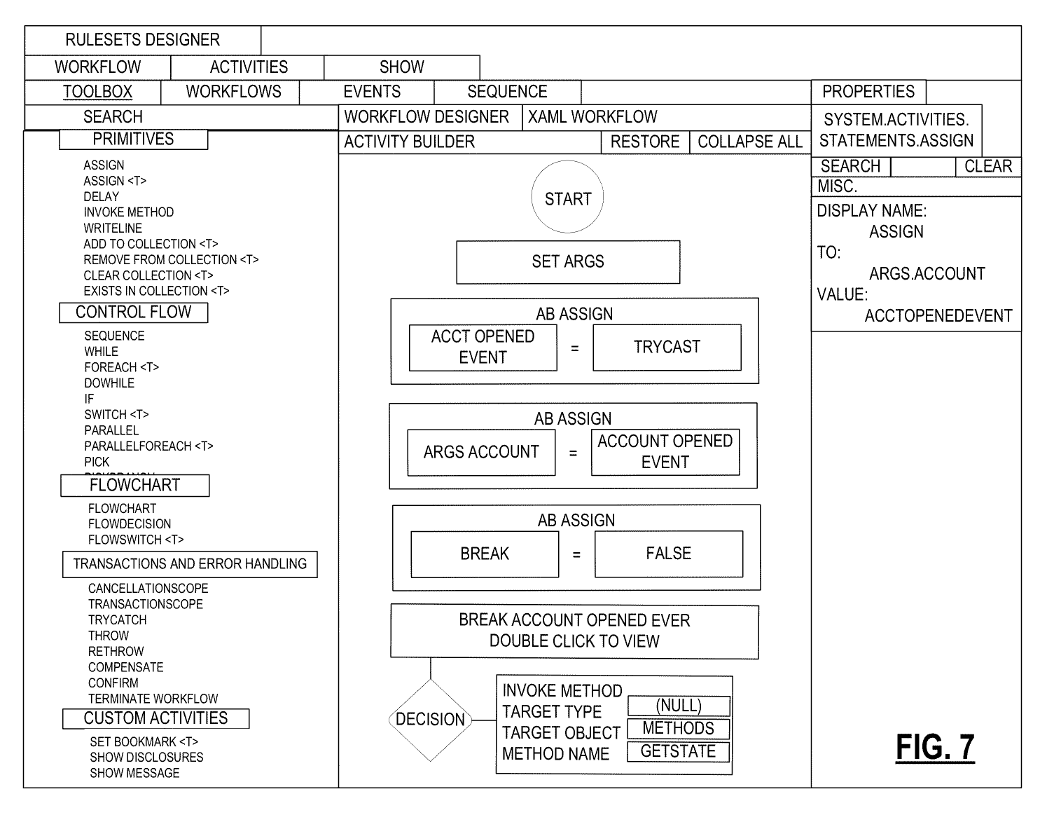

In FIG. 7, an exemplary screenshot of a graphical representation of a workflow toolbox is provided, in accordance with embodiments of the disclosure. As shown in FIG. 7, a toolbox may be provided to assist users in determining an event that the system is able to monitor and for which an action may be specified. The toolbox provides various options, such as primitive options, control flow options, flowchart options, transactions and error handling, and custom activities, which can be used to define an event as part of a workflow.

As shown in the activity builder screen, a modular workflow design may be provided to the user to allow the user to establish workflow rules. For example, a user may assign an account opening event to a workflow rule.

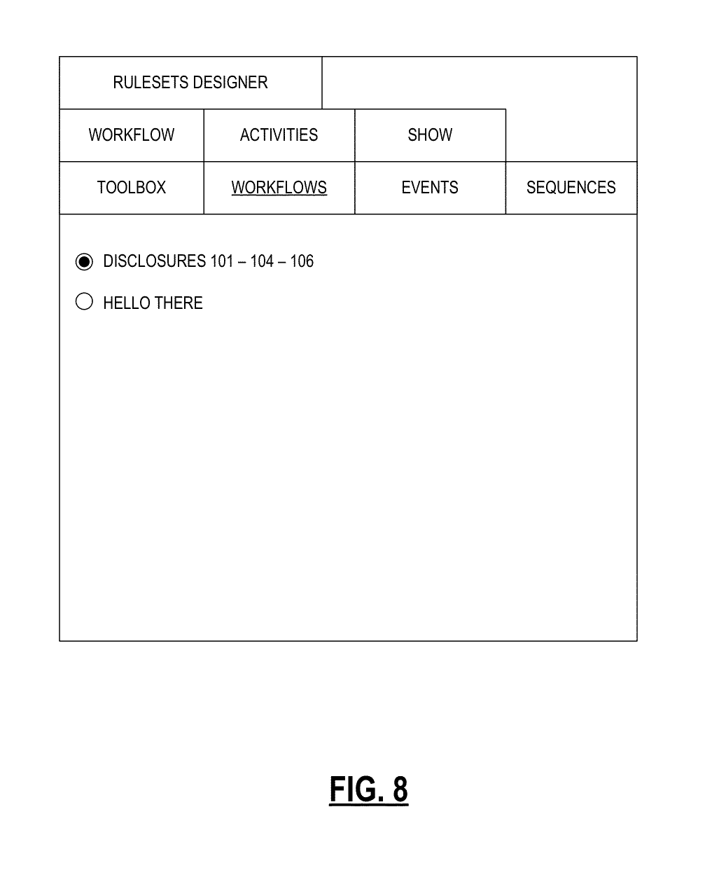

In FIG. 8, an exemplary screenshot of a graphical representation of a workflows window is provided, in accordance with embodiments of the disclosure. The workflows window allows user to select previously used workflows, such as workflows related to disclosures by representatives in a call with a new customer. Once a pre-existing workflow is selected, a rule associated with the workflow may be defined.

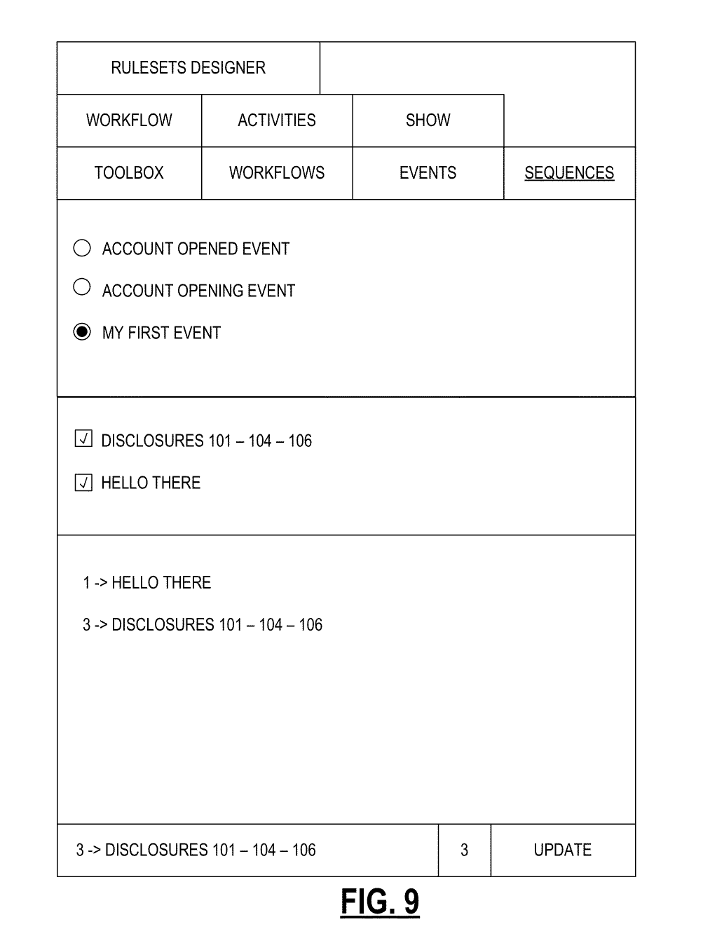

Turning now to FIG. 9, an exemplary screenshot of a graphical representation of a workflow sequence menu is provided, in accordance with embodiments of the disclosure. As shown in FIG. 9, a user can construct a workflow rule by selecting an event and selecting one or more actions to occur in response to the event. For example, the event may be a new account opening up by a customer. When a representative contacts the customer for the first time, the representative is prompted to provide disclosures to the customer regarding the account as well as welcome the customer. This workflow rule can then be implemented for future occurrences of the event.

It should be understood that the exemplary screenshots disclosed herein are but one example of the graphical depictions that may be provided to a customer related to the system and method. Bar charts, pie graphs, and other graphical depictions, as well as graphical user interfaces, prompts, and other input devices may be provided to the customer via the system and method.

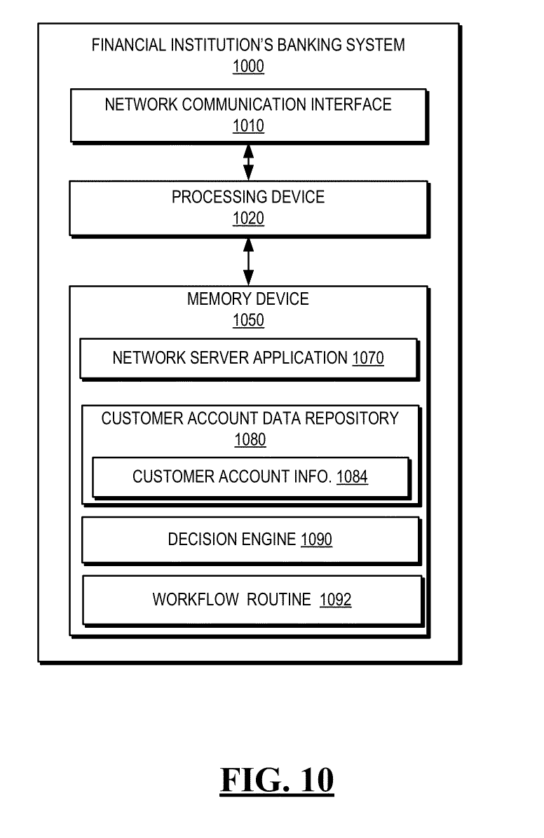

FIG. 10 provides a block diagram illustrating an exemplary financial institution banking system 1000 in greater detail, in accordance with embodiments of the disclosure. The banking system 1000 may be the merchant system that provides for the system and method disclosed in FIGS. 1-3. As illustrated in FIG. 10, in one embodiment, the banking system 1000 includes a processing device 1020 operatively coupled to a network communication interface 1010 and a memory device 1050. In certain embodiments, the banking system 1000 is operated by a first entity, such as a financial institution, while in other embodiments the banking system 1000 is operated by an entity other than a financial institution.

It should be understood that the memory device 1050 may include one or more databases or other data structures/repositories. The memory device 1050 also includes computer-executable program code that instructs the processing device 1020 to operate the network communication interface 1010 to perform certain communication functions of the banking system 1000 described herein. For example, in one embodiment of the banking system 1000, the memory device 1050 includes, but is not limited to, a network server application 1070, a customer account data repository 1080, which includes customer account information 1084, a decision engine 1090, a workflow rules routine 1092, and other computer-executable instructions or other data. The computer-executable program code of the network server application 1070 or the workflow rules routine 1092 may instruct the processing device 1020 to perform certain logic, data-processing, and data-storing functions of the banking system 1000 described herein, as well as communication functions of the banking system 1000.

In an embodiment, the customer account data repository 1080 includes customer account information 1084. The customer account information may include account history for the customer, demographic information for the customer, any notations made by the customer or a representative on the customer's file, and the like. The customer account information 1084 can be used by the system to determine when an event occurs, for example, to determine when a customer opens a new account.

In some embodiments, the workflow routine 1092 receives events and actions from users and implements the workflow rule for future events. In an embodiment, the workflow routine 1092 tracks events as they are occurring on the system via a generic subscription to all events. When an event occurs that is associated with a workflow rule, the decision engine 1090 causes the action to occur, e.g., a pop-up displays information, a representative is prompted in some way, additional information is requested, a connection to a new department or agent is initiated, at the like.

As used herein, a “communication interface” generally includes a modem, server, transceiver, and/or other device for communicating with other devices on a network, and/or a user interface for communicating with one or more users. Referring again to FIG. 10, the network communication interface 1010 is a communication interface having one or more communication devices configured to communicate with one or more other devices on the network, such as a representative work station, an autodialer, a customer contact, and the banking system 1010. The processing device 1020 is configured to use the network communication interface 1010 to transmit and/or receive data and/or commands to and/or from the other devices connected to a network to allow communication between the devices.

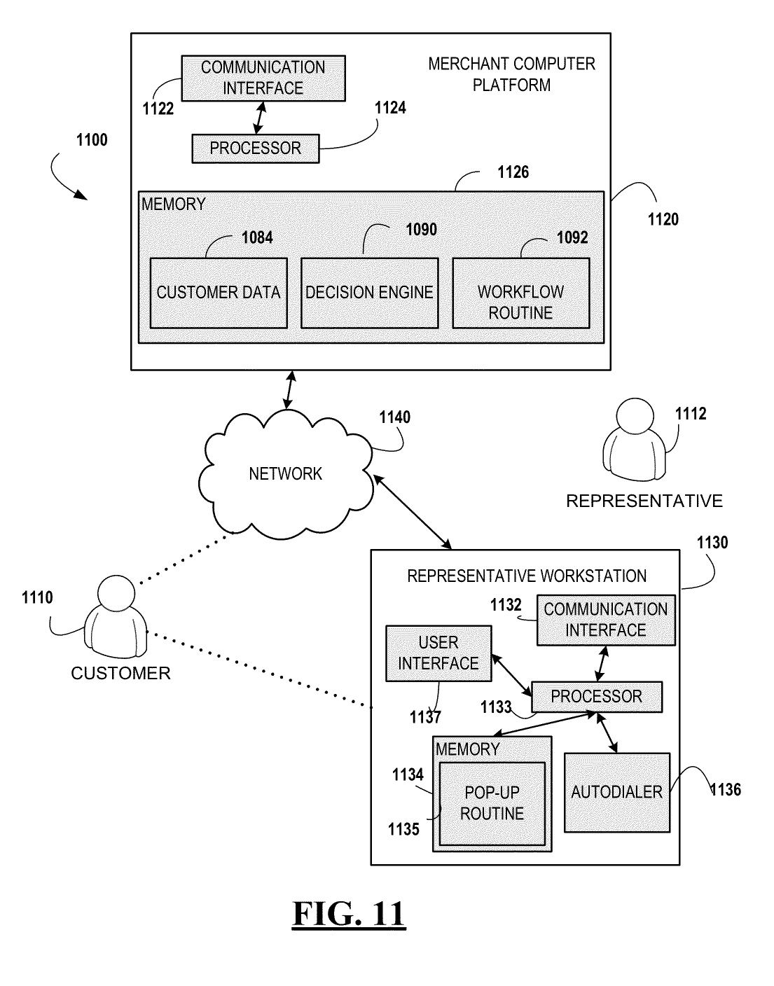

FIG. 11 provides a block diagram illustrating technical components for a system 1100 for providing a workflow rules engine, in accordance with an embodiment of the present disclosure. As illustrated, the system 1100 includes a customer 1110, a merchant computer platform 1120, a representative workstation 1130 for a representative 1112 and a network 1140. It will be understood that the representative 1112 has access to the representative workstation 1130.

As shown in FIG. 11, the merchant computer platform 1120 and representative workstation 1130 are each operatively and selectively connected to the network 1140, which may include one or more separate networks. In addition, the network 1140 may include a local area network (LAN), a wide area network (WAN), and/or a global area network (GAN), such as the Internet. It will also be understood that the network 1140 may be secure and/or unsecure and may also include wireless and/or wireline technology. The network 1140 may be used to communicate with the customer 1110 via a contact.

As shown in FIG. 11, in accordance with some embodiments of the present invention, the representative workstation 1130 includes a communication interface 1132, a processor 1133, a memory 1134 having a pop-up routine 1135 stored therein, an autodialer or a connection to an autodialer 1136, and a user interface 1137. In such embodiments, the communication interface 1132 is operatively and selectively connected to the processor 1133, which is operatively and selectively connected to the user interface 1137, the memory 1134 and the autodialer 1136.

The user interface 1137 may allow the representative workstation 1130 to receive data from the representative 1112. In an embodiment, the representative workstation 1130 may include any of a number of devices allowing the representative 1112 to control the representative workstation 1130 and communicate with the customer 1110, such as a keypad, keyboard, touch-screen, touchpad, microphone, mouse, joystick, stylus, other pointer device, button, soft key, and/or other input device(s). In some embodiments, the user interface 1137 also includes one or more user output devices, such as a display and/or speaker, for presenting information to the representative 1112.

Each communication interface described herein, including the communication interface 1132 and 1122, generally includes hardware, and, in some instances, software, that enables a portion of the system 1100, such as the processor 1133 to transport, send, receive, and/or otherwise communicate information. For example, the communication interface 1132 of the representative workstation 1130 may include a modem, server, electrical connection, and/or other electronic device that operatively connects the representative workstation 1130 to another electronic device, such as the electronic devices that make up the merchant computer platform 1120 and/or the electronic device of the customer 1110.

Each processor described herein, including the processor 1122 and 1124, generally includes circuitry for implementing the audio, visual, and/or logic functions of that portion of the system 1100. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as the memory 1134 of the representative workstation 1130 and the memory 1126 of the merchant computer platform 1120.

Each memory device described herein, including the memory 1134 for storing the pop-up routine 1135 and the memory 1126 of the merchant computer platform 1120, may include any computer-readable medium. For example, memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 11, the memory 1134 of the representative workstation 1130 includes the pop-up routine 1135. The pop-up routine 1135 provides alerts and/or information to the representative as part of a workflow rule. For example, the pop-up routine may determine that the customer resides in a state having restrictions on certain questions during a phone call from a financial institution (an event). The pop-up routine would display a special screen before or during the communication with the customer providing information on the restrictions (an action specified by a workflow rule). In some embodiments, the pop-up routine 1135 includes computer-executable program code portions for instructing the processor 1133 to perform one or more of the functions of the pop-up routine 1135 described and/or contemplated herein.

It will be understood that the representative workstation 1130 can be configured to implement one or more portions of the process flows described and/or contemplated herein. For example, in some embodiments, the representative workstation 1130 is configured so that the communication interface 1132 is operatively and selectively linked to the merchant computer platform 1120 to receive actions that occur in response to events determined by the system. For instance, a representative may be prompted to provide disclosures to a customer based on the customer opening a new account. In other embodiments (not shown) an application may be stored in the memory 1134 of the representative workstation 1130 that enables the workstation to perform some or all of the steps of process flows 300 shown in FIG. 3.

FIG. 11 also illustrates a merchant computer platform 1120, in accordance with an embodiment of the present invention. The merchant computer platform 1120 may include any computerized apparatus that can be configured to perform any one or more of the functions of the merchant computer platform 1120 described and/or contemplated herein. In accordance with some embodiments, for example, the merchant computer platform 1120 may include an engine, a platform, a server, a database system, a front end system, a back end system, a personal computer system, and/or the like. In some embodiments, such as the one illustrated in FIG. 11, the merchant computer platform 1120 includes a communication interface 1122, a processor 1124 and a memory 1126. In some embodiments, as illustrated in FIG. 11, customer data (such as contacts, transactional data, account history data, social network data and Internet data) 1084, a decision engine 1090 for evaluating events that are occurring via the generic subscription and determining when a workflow rule indicates that an action should occur in response to an event, and a workflow routine 1092 may be stored in memory 1126. The customer data 1084 may have been previously collected and stored in the memory 1126 of the merchant computer platform 1120, or the merchant computer platform may actively collect customer data 1084 by using the communication interface 1122 to access the network 1140 and only temporarily saves the customer data 1084 to the memory to be accessed by the processor 1124. The communication interface 1122 is operatively and selectively connected to the processor 1124, which is operatively and selectively connected to the memory 1126.

It will be understood that the merchant computer platform 1120 can be configured to implement one or more portions of the process flows described and/or contemplated herein. For example, in some embodiments, the merchant computer platform 1120 is configured so that the processor uses a decision engine to determine when permission has been received and then instructs the autodialer to communicate with the customer via the contact. In certain embodiments the autodialing routine 1136, stored in memory 1126, is configured to control an autodialer. The autodialer may be integral with the system or may be external to the system yet connected over the network 1140.

It will be understood that the embodiment illustrated in FIG. 11 is exemplary and that other embodiments may vary. For example, in some embodiments, some or all of the portions of the system 1100 may be combined into single portion. Specifically, in some embodiments, the merchant computer platform 1120 is configured to perform all of the same functions of those separate portions as described and/or contemplated herein. Likewise, in some embodiments, some or all of the portions of the system 1100 may be separated into two or more distinct portions.

Embodiments of the present invention are described herein with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer.

Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media

Computer program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for providing a workflow rules engine, the system comprising:
a computer apparatus including a processor and a memory; and
a software module stored in the memory, comprising executable instructions that when executed by the processor cause the processor to:
receive data associated with a plurality of events;
determine an identity of a user reviewing at least one of the plurality of events;
receive a workflow rule from the user relating to at least one of the plurality of events, wherein the workflow rule causes an action to occur in response to a future occurrence of the event; and
implement the rule for future events.

2. The system of claim 1, wherein the module is further configured to:
determine qualifications of the user based on the user's identity; and
determine a subset of events that the user is allowed to control with a workflow rule based on the user's qualifications.

3. The system of claim 1, wherein the event is selected from the group consisting of a customer contact in a specific location, a customer contact at a specific frequency, a customer contact at a specific time, and a new account opening.

4. The system of claim 1, wherein the workflow rule causes information to be provided to a representative when the future event occurs.

5. The system of claim 4, wherein the module is further configured to:
supplement the workflow rule with data associated with the customer; and
provide the data to the representative when the information is provided.

6. The system of claim 1, wherein implementing the rule for future events comprises receiving a generic subscription to all events in the system; comparing the event of the workflow rule to current events; and causing the action to occur based on the comparison between the workflow rule event and the current events.

7. The system of claim 1, wherein receiving the workflow rule from the user comprises providing a graphical toolbox, wherein the graphical toolbox comprises selectable modular events and actions; and receiving one or more selections of events and actions from the user.

8. A computer program product for providing a workflow rules engine, the computer program product comprising:
a non-transitory computer readable storage medium having computer readable program code embodied therewith, the computer readable program code comprising:
a computer readable program code configured to receive data associated with a plurality of events;
a computer readable program code configured to determine an identity of a user reviewing at least one of the plurality of events;
a computer readable program code configured to receive a workflow rule from the user relating to at least one of the plurality of events, wherein the workflow rule causes an action to occur in response to a future occurrence of the event; and
a computer readable program code configured to implement the rule for future events.

9. The computer program product of claim 8, the computer program product further comprising a computer readable program code configured to determine qualifications of the user based on the user's identity; and a computer readable program code configured to determine a subset of events that the user is allowed to control with a workflow rule based on the user's qualifications.

10. The computer program product of claim 8, wherein the event is selected from the group consisting of a customer contact in a specific location, a customer contact at a specific frequency, a customer contact at a specific time, and a new account opening.

11. The computer program product of claim 8, wherein the workflow rule causes information to be provided to a representative when the future event occurs.

12. The computer program product of claim 11, the computer program product further comprising a computer readable program code configured to supplement the workflow rule with data associated with the customer; and a computer readable program code configured to provide the data to the representative when the information is provided.

13. The computer program product of claim 8, wherein implementing the rule for future events comprises receiving a generic subscription to all events in the system; comparing the event of the workflow rule to current events; and causing the action to occur based on the comparison between the workflow rule event and the current events.

14. The computer program product of claim 8, wherein receiving the workflow rule from the user comprises providing a graphical toolbox, wherein the graphical toolbox comprises selectable modular events and actions; and receiving one or more selections of events and actions from the user.

15. A method for providing a workflow rules engine, the method comprising:
receiving data associated with a plurality of events;
determining, via a computing device processor, an identity of a user reviewing at least one of the plurality of events;
receiving a workflow rule from the user relating to at least one of the plurality of events, wherein the workflow rule causes an action to occur in response to a future occurrence of the event; and
implementing, via a computing device processor, the rule for future events.

16. The method of claim 15, the method further comprising:
determining qualifications of the user based on the user's identity; and
determining a subset of events that the user is allowed to control with a workflow rule based on the user's qualifications.

17. The method of claim 15, wherein the event is selected from the group consisting of a customer contact in a specific location, a customer contact at a specific frequency, a customer contact at a specific time, and a new account opening.

18. The method of claim 15, wherein the workflow rule causes information to be provided to a representative when the future event occurs.

19. The method of claim 15, wherein implementing the rule for future events comprises receiving a generic subscription to all events in the system; comparing the event of the workflow rule to current events; and causing the action to occur based on the comparison between the workflow rule event and the current events.

20. The method of claim 15, wherein receiving the workflow rule from the user comprises providing a graphical toolbox, wherein the graphical toolbox comprises selectable modular events and actions; and receiving one or more selections of events and actions from the user.
